(19) United States
(12) Patent Application Publication
(10) Pub. No.: US 2025/0385490 A1
(43) Pub. Date: Dec. 18, 2025

(54) SPARK PLUG

(71) Applicant: Niterra Co., Ltd., Nagoya-shi (JP)

(72) Inventors: Susumu IMAI, Nagoya-shi (JP); Kaito NAKAMURA, Nagoya-shi (JP)

(73) Assignee: Niterra Co., Ltd., Nagoya-shi (JP)

(21) Appl. No.: 19/231,832

(22) Filed: Jun. 9, 2025

(30) Foreign Application Priority Data
Jun. 12, 2024 (JP) 2024-095124

(51) Int. Cl. H01T 13/39; H01T 13/32

(52) U.S. Cl. CPC H01T 13/39; H01T 13/32

(57) ABSTRACT

A spark plug includes an insulator that has an axial hole extending along an axial line; a center electrode that is disposed in the axial hole; a metallic shell that is disposed at the outer periphery of the insulator; and a ground electrode that is connected to the metallic shell. At least one of the center electrode and the ground electrode includes a base material and a chip sealed to the base material and containing Ru as a main constituent, the chip has a discharge surface facing the other one of the center electrode and the ground electrode, and arithmetic average roughness of the discharge surface is 0.4 μm or more and 4.8 μm or less.

### FIELD OF THE INVENTION

The present invention relates to a spark plug that includes a chip containing Ru.

### BACKGROUND OF THE INVENTION

Japanese Unexamined Patent Application Publication No. 5-54955 discloses a related art in which at least one of a center electrode and a ground electrode includes a chip constituted by a single substance of Ru or a Ru alloy.

In the related art, a technology capable of improving ignitability while reducing exhaustion of the chip caused by oxidation is required.

The present invention addresses this requirement, and an object of the present invention is to provide a spark plug in which ignitability can be improved while exhaustion of a chip is reduced.

### SUMMARY OF THE INVENTION

A first aspect of the present invention includes an insulator that has an axial hole extending along an axial line; a center electrode that is disposed in the axial hole; a metallic shell that is disposed at an outer periphery of the insulator; and a ground electrode that is connected to the metallic shell, in which the center electrode includes a base material and a chip sealed to the base material, in which the chip contains Ru as a main constituent and has a discharge surface facing the ground electrode, and in which arithmetic average roughness of the discharge surface is 0.4 μm or more and 4.8 μm or less.

A second aspect includes an insulator that has an axial hole extending along an axial line; a center electrode that is disposed in the axial hole; a metallic shell that is disposed at an outer periphery of the insulator; and a ground electrode that is connected to the metallic shell, in which the ground electrode includes a base material and a chip sealed to the base material, in which the chip contains Ru as a main constituent and has a discharge surface facing the center electrode, and in which arithmetic average roughness of the discharge surface is 0.4 μm or more and 4.8 μm or less.

A third aspect includes an insulator that has an axial hole extending along an axial line; a center electrode that is disposed in the axial hole; a metallic shell that is disposed at an outer periphery of the insulator; and a ground electrode that is connected to the metallic shell, in which the center electrode and the ground electrode each include a base material and a chip sealed to the base material, in which the chip of each of the center electrode and the ground electrode contains Ru as a main constituent and has a discharge surface, the discharge surface of the chip of the center electrode facing the ground electrode, the discharge surface of the chip of the ground electrode facing the center electrode, and in which arithmetic average roughness of the discharge surface is 0.4 μm or more and 4.8 μm or less.

A fourth aspect is any one of the first to third aspects in which arithmetic average roughness of the discharge surface is 3.2 μm or less.

A fifth aspect is any one of the first to fourth aspects in which arithmetic average roughness of the discharge surface is 1.1 μm or more.

A sixth aspect is any one of the first to fifth aspects in which the chip has a side surface contiguous with the discharge surface, and in which a value obtained by dividing arithmetic average roughness of the side surface by arithmetic average roughness of the discharge surface is 0.5 or more and 2.0 or less.

A seventh aspect is any one of the first to sixth aspects in which arithmetic average roughness of a facing surface of the ground electrode facing the discharge surface of the center electrode is smaller than arithmetic average roughness of the discharge surface of the center electrode.

An eighth aspect is any one of the first to seventh aspects in which the base material of the center electrode includes a projection projecting in a direction along the axial line from the insulator toward the ground electrode, and in which arithmetic average roughness of a side surface of the projection is smaller than arithmetic average roughness of the discharge surface of the center electrode.

According to the present invention, it is possible to reduce exhaustion of the chip caused by oxidation since the arithmetic average roughness of the discharge surface of the chip containing Ru as a main constituent is 4.8 μm or less. Further, it is possible to increase the electrical field intensity of the discharge surface and possible to improve ignitability since the arithmetic average roughness of the discharge surface of the chip is 0.4 μm or more.

### BRIEF DESCRIPTION OF THE DRAWINGS

FIG. 1 is a one-side sectional view of a spark plug according to one embodiment.

FIG. 2 is a sectional view of a part where a center electrode and a ground electrode of a spark plug face each other.

### DETAILED DESCRIPTION OF THE INVENTION

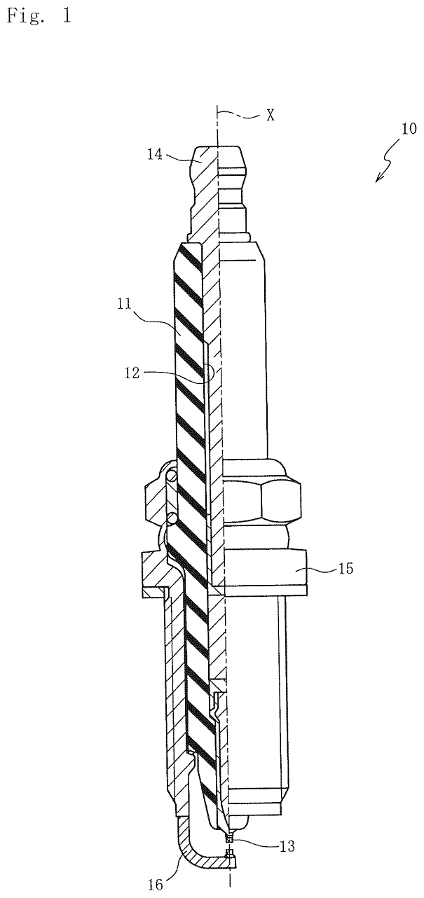

Hereinafter, a preferred embodiment of the present invention will be described with reference to the accompanying drawings. FIG. 1 is a one-side sectional view in which an axial line X of a spark plug 10 according to one embodiment is set as a boundary. The lower side in FIG. 1 will be referred to as the front end side of the spark plug 10, and the upper side in FIG. 1 will be referred to as the rear end side of the spark plug 10.

As illustrated in FIG. 1, the spark plug 10 includes an insulator 11, a center electrode 13, a metallic shell 15, and a ground electrode 16. The insulator 11 is a substantially cylindrical member made of ceramic, such as alumina, excellent in mechanical properties and insulation properties under high temperature. The insulator 11 has an axial hole 12 extending along the axial line X through the insulator 11. The center electrode 13 is rod-shaped electrode disposed along the axial line X in the axial hole 12.

The front end side of a metal terminal 14, which is a rod-shaped member to which an ignition system (not illustrated) is to be connected, is disposed in the axial hole 12 of the insulator 11. The metal terminal 14 is electrically connected in the axial hole 12 to the center electrode 13.

The metallic shell 15 is a substantially cylindrical metallic member that is to be fixed to a screw hole (not illustrated) of an internal combustion engine. The metallic shell 15 is made of an electrically conductive metal material (for example, low-carbon steel or the like). The metallic shell 15 is fixed to the outer periphery of the insulator 11. The ground electrode 16 is connected to the metallic shell 15.

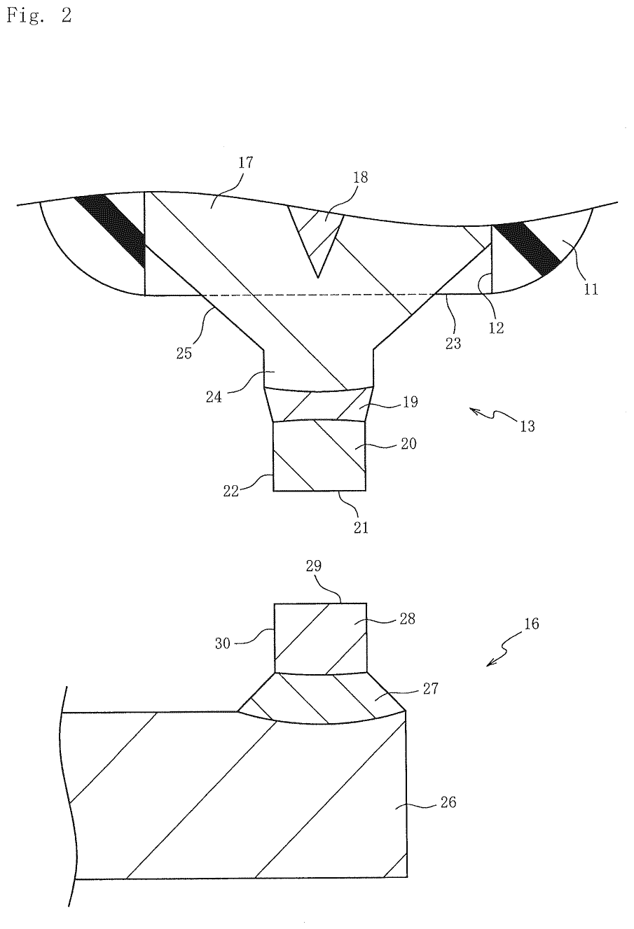

FIG. 2 is a sectional view of a part where the center electrode 13 and the ground electrode 16 of the spark plug 10 face each other. The center electrode 13 includes a base material 17 and a chip 20 at the front end of the base material 17.

A core material 18 excellent in thermal conductivity is embedded in the base material 17. The material of the base material 17 is, for example, Ni or an alloy containing Ni as a main constituent, and the material of the core material 18 is, for example, Cu or an alloy containing Cu as a main constituent. The core material 18 can be omitted.

The chip 20 is sealed to the base material 17 by a molten portion 19. The chip 20 and the base material 17 have melted in the molten portion 19. The molten portion 19 is formed by laser beam welding, resistance welding, diffusion bonding, or the like. The chip 20 has a discharge surface 21 facing the ground electrode 16, and a side surface 22 contiguous with the discharge surface 21.

The base material 17 includes a projection 24 projecting in a direction along the axial line X (refer to FIG. 1) from a front end 23 of the insulator 11. The projection 24 is a portion of the base material 17 present between the front end 23 of the insulator 11 and the molten portion 19. The projection 24 has a side surface 25 surrounding the axial line X.

The ground electrode 16 includes a base material 26 connected to the metallic shell 15, and a chip 28 at the base material 26. A core material (not illustrated) excellent in thermal conductivity is embedded in the base material 26. The material of the base material 26 is an alloy containing Ni as a main constituent, and the material of the core material is Cu or an alloy containing Cu as a main constituent. The core material can be omitted. An intermediate member projecting toward the center electrode 13 may be provided at the base material 26, and the chip 28 may be sealed to the intermediate member. The intermediate member is a portion of the base material 26.

The chip 28 is sealed to the base material 26 by a molten portion 27. The chip 28 and the base material 26 have melted in the molten portion 27. The molten portion 27 is formed by laser beam welding, resistance welding, diffusion bonding, or the like. The chip 28 has a discharge surface 29 facing the center electrode 13, and a side surface 30 contiguous with the discharge surface 29.

At least one of the chips 20 and 28 contains Ru as a main constituent. Containing Ru as a main constituent means that, among elements constituting the chip 20 or 28, the element whose content is the largest is Ru. The content of Ru is preferably 50 mass % or more and is more preferably 60 mass % or more or 70 mass % or more with respect to the total amount of all components constituting the chip 20 or 28.

When the chip 20 of the center electrode 13 contains Ru as a main constituent or the chip 28 of the ground electrode 16 contains Ru as a main constituent, elements constituting the chip 20 or 28 other than Ru are, for example, one or more elements selected from Rh, Pd, Os, Ir, Pt, Ta, W, Mo, Nb, Re, Cr, Mn, Fe, Co, Ni, V, Ti, Zr, Hf, Al, and Sc.

When the chip 20 of the center electrode 13 contains Ru as a main constituent, the ground electrode 16 is any one of a ground electrode that includes the chip 28 containing Ru as a main constituent, a ground electrode that includes the chip 28 containing as a main constituent one or more platinum group elements (Rh, Pd, Os, Ir, Pt) other than Ru, and a ground electrode in which the molten portion 27 and the chip 28 are not provided at the base material 26.

When the chip 28 of the ground electrode 16 contains Ru as a main constituent, the center electrode 13 is any one of a center electrode that includes the chip 20 containing Ru as a main constituent, a center electrode that includes the chip 20 containing one or more platinum group elements (Rh, Pd, Os, Ir, Pt) other than Ru, and a center electrode in which the molten portion 19 and the chip 20 are not provided at the base material 17.

The spark plug 10 is formed by, for example, the following method. First, the center electrode 13 is inserted into the axial hole 12 of the insulator 11. Next, after the metal terminal 14 is inserted into the axial hole 12 and electrical continuity between the metal terminal 14 and the center electrode 13 is ensured, the metallic shell 15 to which the ground electrode 16 is previously connected is assembled to the outer periphery of the insulator 11. A spark gap is formed between the center electrode 13 and the ground electrode 16 by bending the ground electrode 16, thereby obtaining the spark plug 10.

The chips 20 and 28 containing Ru as a main constituent are each formed by, for example, sintering a molded body of metal powder containing Ru, punching a metal plate material containing Ru, or cutting a metal wire material containing Ru. The shape of each of the chips 20 and 28 is not limited and is, for example, a shape of a circular plate, a truncated cone, an elliptical cylinder, or a polygonal cylinder such as a triangular cylinder or a quadrangular cylinder.

When the chip 20 of the center electrode 13 contains Ru as a main constituent, the arithmetic average roughness of the discharge surface 21 of the chip 20 is 0.4 μm or more and 4.8 μm or less. When electric discharges between the center electrode 13 and the ground electrode 16 mainly occur between the discharge surface 21 of the chip 20 and the ground electrode 16, flame quenching caused by the center electrode 13 can be reduced, leading to an improvement in ignitability. The rougher the discharge surface 21, the larger the electrical field intensity, and, when the arithmetic average roughness of the discharge surface 21 is 0.4 μm or more, ignitability improves since electric discharges easily occur at the discharge surface 21. When the arithmetic average roughness of the discharge surface 21 is 1.1 μm or more, efficiency in improving ignitability is increased, which is preferable.

As for the chip 20 containing Ru, the rougher the discharge surface 21, the more easily the chip 20 is exhausted due to oxidation. When the arithmetic average roughness of the discharge surface 21 is 4.8 μm or less, exhaustion of the chip 20 due to oxidation can be reduced. When the arithmetic average roughness of the discharge surface 21 is 3.2 μm or less, efficiency in reducing exhaustion of the chip 20 is increased, which is preferable.

The arithmetic average roughness of the discharge surface 21 indicates an average of the absolute values of the heights of a roughness curve that is obtained by scanning the discharge surface 21 with a laser beam and measuring a contour curve (roughness curve) of a reference length by a non-contact three-dimensional laser measuring device. A range of 10% of the diameter (the length of a line segment passing through the center of gravity of the discharge surface 21) of the discharge surface 21 from the edge of the discharge surface 21 is excluded, and a roughness curve of a part on the inner side of the range is obtained. This is because the surface roughness of the part excluding the range is required to be managed so that electric discharges occur easily at the part excluding the range since electrical field intensity is high at the edge (a corner at which the discharge surface 21 meets the side surface 22) of the discharge surface 21 and electric discharges easily occur at the edge.

The reference length is set to 0.1 mm or more and is preferably set to, for example, 25% of the diameter of the discharge surface 21. This is for ensuring measurement accuracy. For example, the arithmetic average roughness of each of twelve portions of the discharge surface 21 is measured with a scanning interval of 2 μm or more, five values of the arithmetic average roughness are selected in order from the greatest value from values of the arithmetic average roughness of the twelve portions, and the discharge surface 21 is formed such that an average of the five values falls within the range of 0.4 μm to 4.8 μm. The reason for averaging the five values of the arithmetic average roughness selected in order from the greatest value is that, when a part having large arithmetic average roughness is present in the discharge surface 21, electric discharge easily occurs at the part and oxidation exhaustion also easily occurs at the part.

A value obtained by dividing the arithmetic average roughness of the side surface 22 of the chip 20 by the arithmetic average roughness of the discharge surface 21 is preferably 0.5 or more and 2.0 or less. This value being 0.5 or more indicates that the arithmetic average roughness of the side surface 22 has a certain value, and electric discharges occur easily also at the side surface 22 of the chip 20 and electrical field intensity at the discharge surface 21 and the side surface 22 of the chip 20 can be increased. As a result, ignitability can be improved since electric discharges easily occur between the ground electrode 16 and the discharge surface 21 of the chip 20 closest to the ground electrode 16 and flame quenching does not occur easily. This value being 2.0 or less indicates that the side surface 22 is not too rough, which is preferable since electric discharges at the side surface 22 due to concentration of the electric field at the rough side surface 22 can be reduced.

The arithmetic average roughness of the side surface 22 indicates an average of the absolute values of the heights of a roughness curve that is obtained by scanning the side surface 22 in an axial direction with a laser beam and measuring a contour curve (roughness curve) of a reference length by a non-contact three-dimensional laser measuring device. A roughness curve of the side surface 22 in the axial direction from a portion spaced away by 0.1 mm from the edge of the side surface 22 at which the side surface 22 meets the discharge surface 21 is obtained. This is because the surface roughness of a part excluding a range within 0.1 mm from the edge of the side surface 22 is required to be managed so that electric discharges occur easily at a part excluding the edge of the side surface 22 since electrical field intensity is high at the edge (a corner at which the discharge surface 21 meets the side surface 22) of the side surface 22 and electric discharges easily occur at the edge.

The reference length is preferably set to 0.1 mm or more. This is for ensuring measurement accuracy. For example, the arithmetic average roughness of each of twelve portions of the side surface 22 set with equal intervals is measured, five values of the arithmetic average roughness are selected in order from the greatest value from values of the arithmetic average roughness of the twelve portions, and an average of the five values is obtained. The reason for averaging the five values of the arithmetic average roughness selected in order from the greatest value is that, when a part with large arithmetic average roughness is present in the side surface 22, electric discharges easily occur at the part and oxidation exhaustion also easily occurs at the part.

The arithmetic average roughness of each of the discharge surface 21 and the side surface 22 of the chip 20 can be set by causing blasting materials or balls to hit the surfaces of the chip 20 by blasting, such as shot blasting or sand blasting, or ball milling. When the chip 20 is to be manufactured by sintering a molded product of metal powder, it is also possible to set the arithmetic average roughness of each of the discharge surface 21 and the side surface 22 by adjusting particle-diameter distribution of the metal powder. When the chip 20 is to be manufactured by punching a plate material, it is possible to set the arithmetic average roughness of the discharge surface 21 of the chip 20 by punching the plate material after setting surface roughness by causing blasting materials to hit a surface of the plate material.

The arithmetic average roughness of a facing surface (the discharge surface 29 of the chip 28 in the present embodiment) of the ground electrode 16 facing the discharge surface 21 of the chip 20 is preferably smaller than the arithmetic average roughness of the discharge surface 21. Since temperature increases at the facing surface of the ground electrode 16 more easily than at the discharge surface 21 of the center electrode 13, it is possible by setting the arithmetic average roughness of the facing surface of the ground electrode 16 to be smaller than the arithmetic average roughness of the discharge surface 21 to reduce premature ignition caused by a fire source at a rough part of the facing surface of the ground electrode 16.

Measurement of the arithmetic average roughness of the facing surface of the ground electrode 16 is performed as with the measurement of the arithmetic average roughness of the discharge surface 21, and description thereof is thus omitted. The facing surface of the ground electrode 16 in which the molten portion 27 and the chip 28 are not provided at the base material 26 is a surface (surface having the same size as the discharge surface 21) obtained by projecting the discharge surface 21 of the center electrode 13 onto the base material 26 of the ground electrode 16 perpendicularly to the discharge surface 21.

The arithmetic average roughness of the side surface 25 of the projection 24 is preferably smaller than the arithmetic average roughness of the discharge surface 21. This is because, when the arithmetic average roughness of the side surface 25 of the projection 24 is smaller than the arithmetic average roughness of the discharge surface 21, irregular electric discharges (commonly known as side sparks) occurring between the side surface 25 of the projection 24 and the metallic shell 15 can be reduced.

The arithmetic average roughness of the side surface 25 of the projection 24 indicates an average of the absolute values of the heights of a roughness curve that is obtained by scanning the side surface 25 in an axial direction with a laser beam and measuring a contour curve (roughness curve) of a reference length by a non-contact three-dimensional laser measuring device. A roughness curve of the side surface 25 in the axial direction from a portion spaced away by 0.1 mm from the front end 23 of the insulator 11 is obtained. This is because irregular electric discharges do not occur easily at a portion of the projection 24 near the front end 23 of the insulator 11 since the portion is shaded by the insulator 11. The reference length is preferably set to 0.1 mm or more. This is for ensuring measurement accuracy. For example, the arithmetic average roughness of each of twelve portions of the side surface 25 set with equal intervals is measured, and an average of the values of the arithmetic average roughness is obtained.

The side surface 25 of the projection 24 at the front end 23 of the insulator 11 is a conical surface tapered toward the front end side in the present embodiment but is not limited thereto. Depending on the length of the base material 17 of the center electrode 13, the length of the insulator 11, and the shape of the base material 17, the side surface 25 of the projection 24 at the front end 23 of the insulator 11 may be a cylindrical surface. Even when the side surface 25 of the projection 24 at the front end 23 of the insulator 11 is a cylindrical surface, the arithmetic average roughness of the side surface 25 is measured as with the measurement when the side surface 25 is a conical surface.

When the chip 28 of the ground electrode 16 contains Ru as a main constituent, the arithmetic average roughness of the discharge surface 29 of the chip 28 is 0.4 μm or more and 4.8 μm or less, as with the chip 20 of the center electrode 13, and is preferably 1.1 μm or more and 3.2 μm or less. Further, a value obtained by dividing the arithmetic average roughness of the side surface 30 of the chip 28 by the arithmetic average roughness of the discharge surface 29 is preferably 0.5 or more and 2.0 or less. A reason why these ranges are preferred and a method of measuring the arithmetic average roughness are the same as the reason and the method of measuring the arithmetic average roughness that are described for the center electrode 13.

### EXAMPLE

The present invention will be described more specifically with an example but is not limited to this example.

### Test 1

After preparing a plate material made of a Ru—Pt alloy containing 15 mass % of Pt and the remainder of Ru, a plate material made of a Ru—Ni alloy containing 10 mass % of Ni and the remainder of Ru, and a plate material made of a Ru—Co alloy containing 10 mass % of Co and the remainder of Ru, a tester obtained plate materials with various surface roughness by causing blasting materials to hit surfaces of the plate materials. Disk-shaped chips having various discharge surface roughness and each having a diameter of 0.8 mm and a thickness of 0.6 mm were obtained by punching the plate materials.

The tester disposed a center electrode, in which a chip was sealed to a base material, in an insulator and assembled a metallic shell, to which a ground electrode was connected, to the outer periphery of the insulator. Before the ground electrode was bent, a surface shape in a circular range, excluding a range of 0.08 mm on the inner side from the edge of the discharge surface of the chip, with a diameter of 0.64 mm was measured by using a non-contact three-dimensional shape measuring device (INFINITE FOCUS G4, manufactured by Bruker Alicona GmbH). The tester obtained arithmetic average roughness by arbitrarily drawing a normal line of a circle in the circular range and measuring, for every 2 μm, the surface shape of a length of 0.2 mm on the normal line between the center and the circumference of the circle. The arithmetic average roughness of each of twelve portions in total was obtained by radially drawing, with this normal line used as a reference, eleven normal lines at an interval of 30° provided therebetween and measuring, for every 2 μm, the surface shape of a length of 0.2 mm on each normal line. Five values of the arithmetic average roughness were selected in order from the greatest value from values of the arithmetic average roughness of the twelve portions, and an average of the five values was set as a representative value.

After the arithmetic average roughness of the discharge surface of the chip was measured, the ground electrode was bent such that the ground electrode does not touch the discharge surface, thereby obtaining each of spark plug samples No. 1 to No. 20 in each of which a spark gap was provided between the chip of the center electrode and the ground electrode. The size (distance between the discharge surface of the center electrode and the facing surface of the ground electrode) of the spark gap of each sample was 1.3 mm.

After a spark plug was mounted in a pressure chamber provided with a high-speed camera capable of imaging a state inside the pressure chamber, air pressure in the pressure chamber was set to 2 Mpa by filling the pressure chamber with air. A voltage was applied between the center and the ground electrode by an ignition system, and the state of electric discharges was imaged by the high-speed camera.

Images imaged by the high-speed camera were examined, and the number of electric discharges (regular electric discharges) occurred between the discharge surface of the chip of the center electrode and the ground electrode and the number of electric discharges (irregular electric discharges) occurred between the center electrode, other than the discharge surface, of the chip and the ground electrode were counted within 100 times of electric discharges. Samples in each of which the proportion of regular electric discharges was 80% or more were classified as A, samples in each which the proportion of regular electric discharges was 70% or more and less than 80% were classified as B, and samples in each of which the proportion of regular electric discharges was less than 70% were classified as C. The arithmetic average roughness (representative value) of the discharge surface and results are shown in the column of regular electric discharge in Table 1.

TABLE 1

| | | roughness of | regular electric | exhaustion |
|---|---|---|---|---|
| No. | material | discharge surface (μm) | discharge | resistance |
| 1 | Ru—Pt | 0.1 | C | A |
| 2 | | 0.3 | C | A |
| 3 | | 0.4 | B | A |
| 4 | | 0.8 | B | A |
| 5 | | 1.0 | B | A |
| 6 | | 1.1 | A | A |
| 7 | | 1.6 | A | A |
| 8 | | 2.4 | A | A |
| 9 | | 3.2 | A | A |
| 10 | | 4.8 | A | B |
| 11 | | 5.0 | A | C |
| 12 | | 6.0 | A | C |
| 13 | Ru—Ni | 0.4 | B | A |
| 14 | | 1.1 | A | A |
| 15 | | 3.2 | A | A |
| 16 | | 4.8 | A | B |
| 17 | Ru—Co | 0.4 | B | A |
| 18 | | 1.1 | A | A |
| 19 | | 3.2 | A | A |
| 20 | | 4.8 | A | B |

### Test 2

After mounting each of the samples No. 1 to No. 20 in a gasoline engine having a displacement of 1.3 L, the tester performed a test in which the engine was operated at the engine revolution of 5000 rpm for 100 hours with the intake throttle valve fully opened. The temperature of the chip was 700° C. The temperature of the chip was measured before the test was started, by using a spark plug in which a hole reaching a portion near the chip was formed and disposing a temperature measuring junction of a thermocouple at a portion near the front end of the base material close to the chip.

After the test, each sample was taken out, and the size of the gap (spark gap) between the discharge surface of the chip of the center electrode and the ground electrode was measured by using a pin-type gauge, and an increased amount of the spark gap after the test compared with the amount of the spark gap before the test was calculated. Samples in each of which the increased amount of the spark gap was less than 0.03 mm were classified as A, samples in each of which the increased amount of the spark gap was 0.03 mm or more and less than 0.05 mm were classified as B, and samples in each of which the increased amount of the spark gap was 0.05 mm or more were classified as C. Results are shown in the column of exhaustion resistance in Table 1.

As shown in Table 1, the samples No. 3 to No. 20 were classified as A or B regarding regular electric discharges. In particular, the samples No. 6 to No. 12, No. 14 to No. 16, and No. 18 to No. 20 were classified as A regarding regular electric discharges. The samples No. 1 to No. 10 and No. 13 to No. 20 were classified as A or B regarding exhaustion resistance. In particular, the samples No. 1 to No. 9, No. 13 to No. 15, and No. 17 to No. 19 were classified as A regarding regular electric discharges.

Consequently, it has been found that the proportion of regular electric discharges can be 70% or more when the arithmetic average roughness of the discharge surface is 0.4 μm or more. In particular, it has been found that the proportion of regular electric discharges can be 80% or more when the arithmetic average roughness of the discharge surface is 1.1 μm or more. Occurrence of an irregular electric discharge increases a possibility that a flame kernel generated by the electric discharge disappears due to flame quenching. Accordingly, increasing the proportion of regular electric discharges by setting the arithmetic average roughness of the discharge surface to 0.4 μm or more leads to an improvement in ignitability.

In addition, it has been found that the increased amount of the spark gap can be less than 0.05 mm when the arithmetic average roughness of the discharge surface is 4.8 μm or less. In particular, it has been found that the increased amount of the spark gap can be less than 0.03 mm when the arithmetic average roughness of the discharge surface is 3.2 μm or less. Accordingly, it has been found that the arithmetic average roughness of the discharge surface of the chip is required to be 0.4 μm or more and 4.8 μm or less to ensure the proportion of regular electric discharges and further improve the exhaustion resistance of the chip. It has been found that the arithmetic average roughness of the discharge surface is preferably 1.1 μm or more to further increase the proportion of regular electric discharges and that the arithmetic average roughness of the discharge surface is preferably 3.2 μm or less to improve the exhaustion resistance.

### Test 3

After preparing disk-shaped chips each made of a Ru—Pt alloy containing 15 mass % of Pt and the remainder of Ru and each having a diameter of 0.8 mm and a thickness of 0.6 mm, the tester obtained chips with various surface roughness by causing blasting materials to hit the discharge surface and the side surface of each chip. The tester disposed a center electrode, in which a chip was sealed to a base material, in an insulator and assembled a metallic shell, to which a ground electrode was connected, to the outer periphery of the insulator. Before the ground electrode was bent, arithmetic average roughness in a circular range having a diameter of 0.64 mm excluding a range of 0.08 mm on the inner side from the edge of the discharge surface of the chip and the arithmetic average roughness of a part in the axial direction excluding a range of 0.1 mm on the inner side from the edge of the side surface of the chip were measured by using a non-contact three-dimensional shape measuring device (INFINITE FOCUS G4, manufactured by Bruker Alicona GmbH). The tester measured the arithmetic average roughness of the discharge surface of the chip in the same manner as in the test 1, selected five values of the arithmetic average roughness in order from the greatest value from values of the arithmetic average roughness of twelve portions, and set an average of the five values as a representative value.

The tester obtained the arithmetic average roughness of the side surface of the chip by arbitrarily drawing a straight line parallel to the axis of the chip on the side surface of the chip and measuring, for every 2 μm, the surface shape of a length of 0.2 mm on the straight line including the center of the height of the chip. The arithmetic average roughness of each of the twelve portions at equal intervals in the circumferential direction was obtained, five values of the arithmetic average roughness were selected in order from the greatest value from values of the arithmetic average roughness of the twelve portions, and an average of the five values was set as a representative value.

After the arithmetic average roughness of each of the discharge surface and the side surface of the chip was measured, the ground electrode was bent such that the ground electrode does not touch the chip, thereby obtaining each of spark plug samples No. 21 to No. 43 in each of which a spark gap was provided between the chip of the center electrode and the ground electrode. The same test as the test 1 was performed on each sample in which the size of the spark gap was 1.3 mm.

Samples in each of which the proportion of regular electric discharges was 90% or more were classified as S, samples in each of which the proportion of regular electric discharges was 80% or more and less than 90% were classified as A, and samples in each of which the proportion of regular electric discharges was 70% or more and less than 80% were classified as B. Table 2 shows the arithmetic average roughness (representative value) of each of the discharge surface and the side surface, a value Q/P obtained by dividing arithmetic average roughness Q of the side surface by arithmetic average roughness P of the discharge surface, and results.

TABLE 2

| | |
|---|---|
| roughness (μm) | regular |

| | discharge | side | | electric |
|---|---|---|---|---|
| No. | surface P | surface Q | Q/P | discharge |
| 21 | 0.4 | 0.1 | 0.3 | B |
| 22 | | 0.2 | 0.5 | A |
| 23 | | 0.4 | 1.0 | A |
| 24 | | 0.8 | 2.0 | A |
| 25 | | 1.6 | 4.0 | B |
| 26 | | 3.2 | 8.0 | B |
| 27 | 1.1 | 0.1 | 0.1 | A |
| 28 | | 0.6 | 0.5 | S |
| 29 | | 1.1 | 1.0 | S |
| 30 | | 2.2 | 2.0 | S |
| 31 | | 3.2 | 2.9 | A |
| 32 | 1.6 | 0.1 | 0.1 | A |
| 33 | | 0.8 | 0.5 | S |
| 34 | | 1.6 | 1.0 | S |
| 35 | | 3.2 | 2.0 | S |
| 36 | | 4.8 | 3.0 | A |
| 37 | 3.2 | 0.1 | 0.0 | A |
| 38 | | 1.6 | 0.5 | S |
| 39 | | 3.2 | 1.0 | S |
| 40 | 4.8 | 0.1 | 0.0 | A |
| 41 | | 1.6 | 0.3 | A |
| 42 | | 3.2 | 0.7 | S |
| 43 | | 4.8 | 1.0 | S |

As shown in Table 2, the samples No. 22 to No. 24 among samples in each of which the arithmetic average roughness of the discharge surface was 0.4 μm were classified as A regarding regular electric discharges, and the samples No. 28 to No. 30 among samples in each of which the arithmetic average roughness of the discharge surface was 1.1 μm were classified as S regarding regular electric discharges. The samples No. 33 to No. 35 among samples in each of which the arithmetic average roughness of the discharge surface was 1.6 μm were classified as S regarding regular electric discharges, and the samples No. 38 and No. 39 among samples in each of which the arithmetic average roughness of the discharge surface was 3.2 μm were classified as S regarding regular electric discharges. The samples No. 42 and No. 43 among samples in each of which the arithmetic average roughness of the discharge surface was 4.8 μm were classified as S regarding regular electric discharges. According to the example, it has been found that the proportion of regular electric discharges can be further increased and ignitability can be improved when the value Q/P, which is obtained by dividing the arithmetic average roughness Q of the side surface of the chip by the arithmetic average roughness P of the discharge surface, is 0.5 or more and 2.0 or less.

### Test 4

After preparing disk-shaped chips each made of a Ru—Pt alloy containing 15 mass % of Pt and the remainder of Ru and each having a diameter of 0.8 mm and a thickness of 0.6 mm and base materials (for center electrodes), the tester obtained chips with various surface roughness by causing blasting materials to hit the discharge surface and the side surface of each chip. Further, base materials with various surface roughness were obtained by causing blasting materials to hit a portion near the front end of each base material. The tester disposed a center electrode, in which a chip was sealed to a base material, in an insulator and assembled a metallic shell, to which a ground electrode was connected, to the outer periphery of the insulator. Before the ground electrode was bent, arithmetic average roughness in a circular range having a diameter of 0.64 mm excluding a range of 0.08 mm on the inner side from the edge of the discharge surface of the chip and the arithmetic average roughness of a side surface of a projection of each base material were measured by using a non-contact three-dimensional shape measuring device (INFINITE FOCUS G4, manufactured by Bruker Alicona GmbH).

The tester measured the arithmetic average roughness of the discharge surface of the chip in the same manner as in the test 1, selected five values of the arithmetic average roughness in order from the greatest value from values of the arithmetic average roughness of twelve portions, and set an average of the five values as a representative value. The tester measured the arithmetic average roughness of the side surface of the projection on the front end side from a position spaced away by 0.1 mm from a part where the side surface of the projection meets the front end of the insulator toward the front end side in the axial direction in the same manner as with the arithmetic average roughness of the side surface of each chip in the test 3, thereby obtaining the arithmetic average roughness of each of twelve portions at equal intervals in the circumferential direction. An average of the values of the arithmetic average roughness of the twelve portions was set as a representative value of the projection.

After the arithmetic average roughness of each of the chip and the projection was measured, the ground electrode was bent such that the ground electrode does not touch the chip and the projection, thereby obtaining each of spark plug samples No. 44 to No. 51 in each of which a spark gap was provided between the chip of the center electrode and the ground electrode. The size of the spark gap of each sample was 1.3 mm. In addition to the conditions in the test 1, an air flow (flow rate 5 L/minute) flowing across the spark gap was provided in the pressure chamber, and the same test as the test 1 was performed.

Samples in each of which the proportion of regular electric discharges was 90% or more were classified as S, samples in each of which the proportion of regular electric discharges was 80% or more and less than 90% were classified as A, and samples in each of which the proportion of regular electric discharges was 70% or more and less than 80% were classified as B. Table 3 shows the arithmetic average roughness (representative value) of each of the discharge surface of the chip and the side surface of the projection and results.

TABLE 3

| | roughness of | roughness of | regular electric |
|---|---|---|---|
| No. | discharge surface (μm) | projection (μm) | discharge |
| 44 | 0.4 | 5.0 | B |
| 45 | | 0.1 | A |
| 46 | 1.1 | 5.0 | A |
| 47 | | 0.1 | S |
| 48 | 3.2 | 5.0 | A |
| 49 | | 0.1 | S |
| 50 | 4.8 | 5.0 | A |
| 51 | | 0.1 | S |

As shown in Table 3, it has been found that the proportion of regular electric discharges is larger in the samples No. 45, No. 47, No. 49, and No. 51, in each of which the arithmetic surface roughness of the side surface of the projection is smaller than the arithmetic average roughness of the discharge surface of the chip than in the samples No. 44, No. 46, No. 48, and No. 50, in each of which the arithmetic surface roughness of the side surface of the projection is larger than the arithmetic average roughness of the discharge surface of the chip. It has been found that the proportion of regular electric discharges can be further increased and ignitability can be improved by setting the arithmetic average roughness of the discharge surface of the chip to be larger than the arithmetic average roughness of the side surface of the projection.

### Test 5

After preparing disk-shaped chips each made of a Ru—Pt alloy containing 15 mass % of Pt and the remainder of Ru and each having a diameter of 0.8 mm and a thickness of 0.6 mm and ground electrodes, the tester obtained chips with various surface roughness by causing blasting materials to hit the discharge surface of each chip. Further, ground electrodes with various surface roughness were obtained by causing blasting materials to hit a facing surface of each ground electrode. The tester disposed a center electrode, in which a chip was sealed to a base material, in an insulator and assembled a metallic shell, to which a ground electrode was connected, to the outer periphery of the insulator. Before the ground electrode was bent, arithmetic average roughness in a circular range having a diameter of 0.64 mm excluding a range of 0.08 mm on the inner side from the edge of the discharge surface of the chip and arithmetic average roughness in a circular range having a diameter of 0.64 mm excluding a range of 0.08 mm on the inner side from the edge of the facing surface of the ground electrode were measured in the same manner as in the test 1 by using a non-contact three-dimensional shape measuring device (INFINITE FOCUS G4, manufactured by Bruker Alicona GmbH), five values of the arithmetic average roughness were selected in order from the greatest value from values of the arithmetic average roughness of twelve portions, and an average of the five values was set as a representative value.

After the arithmetic average roughness was measured, the ground electrode was bent such that the ground electrode does not touch the discharge surface of the chip and the facing surface of the ground electrode, thereby obtaining each of spark plug samples No. 52 to No. 58 in each of which a spark gap was provided between the chip of the center electrode and the ground electrode. The size of the spark gap of each sample was 1.3 mm.

The tester mounted each sample in an inline four-cylinder engine with a supercharger and having a displacement of 1.5 L and operated the engine under conditions in which the engine revolution was 2000 rpm and in which indicated mean effective pressure (NMEP) was 1000 kPa. An angle was advanced by 1° each time with respect to a regular ignition timing of an original equipment supplier spark plug of the engine for the test, and an ignition timing at which premature ignition occurred was specified by examining occurrence of pre-ignition (premature ignition) on the basis of a wave form of ion current. Samples in each of which a crank angle at which premature ignition occurred was an angle advanced by 2° or more with respect to a crank angle of the original equipment supplier spark plug were classified as A, and samples in each of which a crank angle at which premature ignition occurred was an angle advanced less than 2° were classified as B. Results are shown in the column of premature ignition in Table 4.

TABLE 4

| | roughness of | roughness of | premature |
|---|---|---|---|
| No. | discharge surface (μm) | facing surface (μm) | ignition |
| 52 | 1.1 | 2.0 | B |
| 53 | | 0.4 | A |
| 54 | 1.6 | 2.0 | B |
| 55 | | 0.2 | A |
| 56 | 3.2 | 4.8 | B |
| 57 | | 0.4 | A |
| 58 | 4.8 | 0.1 | A |

As shown in Table 4, it has been found that premature ignition does not easily occur in the sample No. 53, No. 55, No. 57, and No. 58, in each of which the arithmetic average roughness of the facing surface of the ground electrode is smaller than the arithmetic average roughness of the discharge surface of the chip, compared with samples in each of which the arithmetic average roughness of the facing surface of the ground electrode is larger than the arithmetic average roughness of the discharge surface of the chip. According to the example, it has been found that premature ignition that is caused by a fire source at the discharge surface of the ground electrode can be reduced by setting the arithmetic average roughness of the facing surface of the ground electrode to be smaller than the arithmetic average roughness of the discharge surface of the chip.

Although the present invention has been described above on the basis of an embodiment, the present invention is not limited at all to the aforementioned embodiment, and it can be easily assumed that the present invention can be variously improved or modified within a range that does not deviate from the gist of the present invention.

Although the embodiment in which the ground electrode 16 is bent has been described, the ground electrode 16 is not limited thereto. It is naturally possible to use, as an alternative to the bent ground electrode 16, the ground electrode 16 having a linear shape. In this case, the front end side of the metallic shell 15 is extended in the axial line direction, and the linear ground electrode 16 is sealed to the metallic shell 15. The number of the ground electrodes 16 is also set, as appropriate.

Although the embodiment in which the center electrode 13 and the ground electrode 16 are disposed such that the discharge surface 21 of the chip 20 of the center electrode 13 faces the front end side in the axial line direction has been described, the center electrode 13 and the ground electrode 16 are not necessarily limited thereto. The positional relationship between the center electrode 13 and the ground electrode 16 can be set, as appropriate. As another positional relationship between the center electrode 13 and the ground electrode 16, for example, the chip 20 and the ground electrode 16 are disposed to face each other such that a spark gap is provided between the side surface 22 of the chip 20 of the center electrode 13 and the ground electrode 16. In this case, a surface included in the side surface 22 of the chip 20 and facing the ground electrode 16 corresponds to the discharge surface in claim 1, and the discharge surface 21 of the chip 20 corresponds to the side surface contiguous with the discharge surface. Measurement of the arithmetic average roughness of the discharge surface is performed as with the measurement of the arithmetic average roughness of the side surface 22, and measurement of the arithmetic average roughness of the side surface is performed as with the measurement of the arithmetic average roughness of the discharge surface 21.

### DESCRIPTION OF REFERENCE NUMERALS

10 spark plug
11 insulator
12 axial hole
13 center electrode
15 metallic shell
16 ground electrode
17 base material
20 chip
21 discharge surface
22 side surface
24 projection
25 side surface
26 base material
28 chip
29 discharge surface (facing surface)
30 side surface
X axial line

What is claimed is:

1. A spark plug comprising:
an insulator that has an axial hole extending along an axial line;
a center electrode that is disposed in the axial hole;
a metallic shell that is disposed at an outer periphery of the insulator; and
a ground electrode that is connected to the metallic shell,
wherein the center electrode includes a base material and a chip sealed to the base material,
wherein the chip contains Ru as a main constituent and has a discharge surface facing the ground electrode, and
wherein arithmetic average roughness of the discharge surface is 0.4 μm or more and 4.8 μm or less.

2. A spark plug comprising:
an insulator that has an axial hole extending along an axial line;
a center electrode that is disposed in the axial hole;
a metallic shell that is disposed at an outer periphery of the insulator; and
a ground electrode that is connected to the metallic shell,
wherein the ground electrode includes a base material and a chip sealed to the base material,
wherein the chip contains Ru as a main constituent and has a discharge surface facing the center electrode, and
wherein arithmetic average roughness of the discharge surface is 0.4 μm or more and 4.8 μm or less.

3. A spark plug comprising:
an insulator that has an axial hole extending along an axial line;
a center electrode that is disposed in the axial hole;
a metallic shell that is disposed at an outer periphery of the insulator; and
a ground electrode that is connected to the metallic shell,
wherein the center electrode and the ground electrode each include a base material and a chip sealed to the base material,
wherein the chip of each of the center electrode and the ground electrode contains Ru as a main constituent and has a discharge surface, the discharge surface of the chip of the center electrode facing the ground electrode, the discharge surface of the chip of the ground electrode facing the center electrode, and
wherein arithmetic average roughness of the discharge surface is 0.4 μm or more and 4.8 μm or less.

4. The spark plug according to any one of claims 1,
wherein arithmetic average roughness of the discharge surface is 3.2 μm or less.

5. The spark plug according to any one of claims 1,
wherein arithmetic average roughness of the discharge surface is 1.1 μm or more.

6. The spark plug according to any one of claims 1,
wherein the chip has a side surface contiguous with the discharge surface, and
wherein a value obtained by dividing arithmetic average roughness of the side surface by arithmetic average roughness of the discharge surface is 0.5 or more and 2.0 or less.

7. The spark plug according to claim 1,
wherein arithmetic average roughness of a facing surface of the ground electrode facing the discharge surface is smaller than arithmetic average roughness of the discharge surface.

8. The spark plug according to claim 1,
wherein the base material includes a projection projecting in a direction along the axial line from the insulator toward the ground electrode, and
wherein arithmetic average roughness of a side surface of the projection is smaller than arithmetic average roughness of the discharge surface.

9. The spark plug according to claim 2,
wherein arithmetic average roughness of the discharge surface is 3.2 μm or less.

10. The spark plug according to claim 2,
wherein arithmetic average roughness of the discharge surface is 1.1 μm or more.

11. The spark plug according to claim 2,
wherein the chip has a side surface contiguous with the discharge surface, and
wherein a value obtained by dividing arithmetic average roughness of the side surface by arithmetic average roughness of the discharge surface is 0.5 or more and 2.0 or less.

12. The spark plug according to claim 2,
wherein arithmetic average roughness of a facing surface of the ground electrode facing the discharge surface is smaller than arithmetic average roughness of the discharge surface.

13. The spark plug according to claim 2,
wherein the base material includes a projection projecting in a direction along the axial line from the insulator toward the ground electrode, and
wherein arithmetic average roughness of a side surface of the projection is smaller than arithmetic average roughness of the discharge surface.

14. The spark plug according to claim 3,
wherein arithmetic average roughness of the discharge surface is 3.2 μm or less.

15. The spark plug according to claim 3,
wherein arithmetic average roughness of the discharge surface is 1.1 μm or more.

16. The spark plug according to claim 3,
wherein the chip has a side surface contiguous with the discharge surface, and
wherein a value obtained by dividing arithmetic average roughness of the side surface by arithmetic average roughness of the discharge surface is 0.5 or more and 2.0 or less.

17. The spark plug according to claim 3,
wherein arithmetic average roughness of a facing surface of the ground electrode facing the discharge surface is smaller than arithmetic average roughness of the discharge surface.

18. The spark plug according to claim 3,
wherein the base material includes a projection projecting in a direction along the axial line from the insulator toward the ground electrode, and
wherein arithmetic average roughness of a side surface of the projection is smaller than arithmetic average roughness of the discharge surface.

19. The spark plug according to claim 3,
wherein arithmetic average roughness of a facing surface of the ground electrode facing the discharge surface of the center electrode is smaller than arithmetic average roughness of the discharge surface of the center electrode.

20. The spark plug according to claim 3,
wherein the base material of the center electrode includes a projection projecting in a direction along the axial line from the insulator toward the ground electrode, and
wherein arithmetic average roughness of a side surface of the projection is smaller than arithmetic average roughness of the discharge surface of the center electrode.
